(19) United States
(12) Patent Application Publication
(10) Pub. No.: US 2022/0332245 A1
(43) Pub. Date: Oct. 20, 2022

(54) ILLUMINABLE RESTRAINT HARNESS AND METHOD OF MAKING SAME

(71) Applicant: INDIANA MILLS & MANUFACTURING, INC., Westfield, IN (US)

(72) Inventor: Soren SIBBESEN, Westfield, IN (US)

(21) Appl. No.: 17/635,921

(22) PCT Filed: Oct. 16, 2020
(86) PCT No.: PCT/US2020/055989

§ 371 Date: Feb. 16, 2022

Related U.S. Application Data
(60) Provisional application No. 62/916,570, filed on Oct. 17, 2019.

(51) Int. Cl. B60Q 3/242

(52) U.S. Cl. CPC B60Q 3/242

(57) ABSTRACT

A harness assembly for a vehicle includes a illumination assembly configured to be visible from outside the vehicle. The harness assembly includes a harness pad that includes a passageway through which webbing of the harness assembly extends. The illumination assembly includes a light module and a wiring system coupled to the light module to control light emission from the light module. The light module is configured to be coupled to a front surface of the harness pad of the harness assembly and the wiring extends through a slit in the harness pad to be routed through the passageway of the harness pad. At least a partially light-transmissive cover is configured to extend over the light module and slit and be secured to the front surface of the harness pad.

### CROSS-REFERENCE TO RELATED APPLICATION

This patent application claims the benefit of and priority to U.S. Provisional Patent Application Ser. No. 62/916,570, filed Oct. 17, 2019, the disclosure of which is expressly incorporated herein by reference in its entirety.

### FIELD

This disclosure relates generally to occupant restraint systems for motor vehicles, and more specifically to such restraint systems which include at least one multi-point harness restraint.

### BACKGROUND

Various occupant restraint systems are used to restrain motor vehicle operators and/or occupants. Such restraint systems typically include multiple “points” of securement; that is, such restraint systems may typically be secured at multiple locations to one or more support structures, e.g., via a plurality of restraint webs. Some restraint systems may be formed to include a harness system that extends across one or more upper body portions of a person to restrain an occupant against a back surface of a motor vehicle seat assembly.

### SUMMARY

This disclosure may comprise one or more of the features recited in the attached claims, and/or one or more of the following features and combinations thereof. In one aspect, a harness assembly for a vehicle comprises a shoulder harness portion configured to extend around a torso area of an occupant of the vehicle. The shoulder harness portion comprises a webbing configured to be secured to a frame of the vehicle and a harness pad extending circumferentially around the webbing. The harness pad includes a front surface visible from outside of the vehicle and formed to include a web passage adapted for the webbing to extend through. The webbing extends into the web passage via an opening at a first end of the harness pad. The shoulder harness portion further includes an illumination assembly that includes a light module configured to emit light and a wiring assembly coupled to the light module, the light module coupled to the front surface of the harness pad. The wiring assembly extends through a slit in the front surface of the harness pad to extend into the web passage, and the wiring assembly further extends through the web passage and through the opening at the first end of the harness pad.

In a second aspect, the harness assembly of the first aspect further includes a light-transmissive cover that is secured to the harness pad over the light module and slit formed in the front surface of the harness pad.

In a third aspect, the harness assembly of the first aspect further includes a controller electronically coupled to the wiring assembly to control activation of the light module.

In a fourth aspect, the harness assembly of the first aspect further includes a waist harness portion configured to extend around a waist area of the occupant, the waist portion configured to be secured to the shoulder harness portion via a releasable attachment mechanism.

In a fifth aspect, the harness assembly of the fourth aspect is further provided for wherein both the shoulder harness portion and the waist harness portion are adjustable in length.

In a sixth aspect, the harness assembly of the second aspect is further provided for wherein the light-transmissive cover includes an icon, and light emitted from the light module extends through only a portion of the icon, and a portion of the icon does not permit light from the light module to extend therethrough.

In a seventh aspect, the harness assembly of the first aspect is provided for and wherein the light module includes an LED light.

In an eighth aspect, the harness assembly of the first aspect is provided for and wherein the light module is coupled to the front surface of the harness pad via adhesive.

In a ninth aspect, the harness assembly of the first aspect is provided for and wherein the harness pad is assembled from a sheet of fabric including the slit, and the wiring of the illumination assembly is threaded through the slit before the harness pad is formed to include the web passage.

In a tenth aspect, the harness assembly of the ninth aspect is provided for and wherein the sheet of fabric includes two side edges that are secured together to form a tubed structure surrounding the light module.

In an eleventh aspect, the harness assembly of the first aspect includes two shoulder harness portions configured to extend adjacent two shoulders of an occupant.

In a twelfth aspect, the harness assembly of the first aspect is provided for and wherein the light module is configured to emit multiple colors of light.

In a thirteenth aspect, the harness assembly of the twelfth aspect is provided for and wherein the color of light emitted from the light module depends on a lock status of the harness assembly to a fixed structure within the vehicle.

In a fourteenth aspect, the harness assembly of the twelfth aspect is provided for and wherein the light module is configured not to emit light unless the harness assembly is lockingly secured to a harness buckle coupled to the vehicle frame.

In a fifteenth aspect, a method of assembling a harness assembly for a vehicle is provided. The method comprises forming a sheet of flexible material with a top edge, a bottom edge, and first and second longitudinal side edges extending between the top and bottom edges, the first and second longitudinal side edges having a longer length than the top edge or bottom edge. The method further comprises forming a slit within the sheet of flexible material between the two side edges. The method further comprises inserting an illumination unit of an illumination assembly through the slit to be positioned along a first surface of the sheet, the illumination unit including a wiring assembly extending through the slit. The method further comprises securing the illumination unit to the first surface of the sheet. The method further comprises securing a light-transmissive cover to the first surface of the sheet, the light-transmissive cover being positioned over the illumination unit and the slit. The method further comprises folding the first and second longitudinal side edges together and securing the side edges together from the top edge to the bottom edge to form a tubed structure having a passageway containing the illumination unit and light-transmissive cover. The method further comprises pushing the top or bottom edge through the passageway of the tubed structure and out through the bottom or top edge to turn the tubed structure inside-out and position the illumination unit and light-transmissive cover along an exterior of the tubed structure to form a harness pad including a webbing passageway. The method further comprises placing a webbing material through the webbing passageway of the harness pad, the webbing passageway further including a portion of the wiring assembly extending from the slit.

### BRIEF DESCRIPTION OF THE DRAWINGS

This disclosure is illustrated by way of example and not by way of limitation in the accompanying figures. Where considered appropriate, reference labels have been repeated among the figures to indicate corresponding or analogous elements.

FIG. 1 is a front perspective view of an embodiment of an illuminable multi-point restraint system for a motor vehicle seat, illustrating the restraint system includes a harness assembly, which includes a shoulder harness portion and a waist harness portion, and an illumination assembly that is coupled to the shoulder harness portion of the harness assembly.

FIG. 2 is a front perspective view of the illuminable restraint system of FIG. 1 with a light-transmissive cover or window of the illumination assembly removed to reveal a portion of a light bar assembly of the illumination assembly.

FIG. 3 is an enlarged view of the shoulder harness portion of FIG. 2.

FIG. 4 is a front perspective view of the illuminable restraint system of FIG. 2 with a harness pad or sleeve removed from the shoulder harness portion to further illustrate a wiring system of the illumination assembly that extends between the harness sleeve and a webbing of the shoulder harness portion of the harness assembly.

FIG. 5 is an enlarged view of the shoulder harness portion of FIG. 4.

FIG. 6 is an exploded view of a portion of the enlarged view of the shoulder harness portion of FIG. 5, illustrating the harness sleeve, a strap or webbing of the shoulder harness portion, the illumination assembly, and the light-transmissive cover that covers the illumination assembly when it is assembled with the harness sleeve and surrounds the webbing, the light-transmissive cover extending around an outer perimeter of the light bar of the illumination assembly and around the slit in the harness sleeve through which the wiring assembly extends.

FIG. 7 is a cross-sectional view of a portion of the shoulder harness portion of FIG. 1, as viewed along section lines 7-7 of FIG. 6, illustrating the harness sleeve and illumination assembly.

### DETAILED DESCRIPTION OF THE DRAWINGS

While the concepts of the present disclosure are susceptible to various modifications and alternative forms, specific exemplary embodiments thereof have been shown by way of example in the drawing and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure or characteristic is described in connection with an embodiment, it is submitted that it is within the knowledge of one skilled in the art to effect such feature, structure or characteristic in connection with other embodiments whether or not explicitly described. Further still, it is contemplated that any single feature, structure or characteristic disclosed herein may be combined with any one or more other disclosed feature, structure or characteristic, whether or not explicitly described, and that no limitations on the types and/or number of such combinations should therefore be inferred.

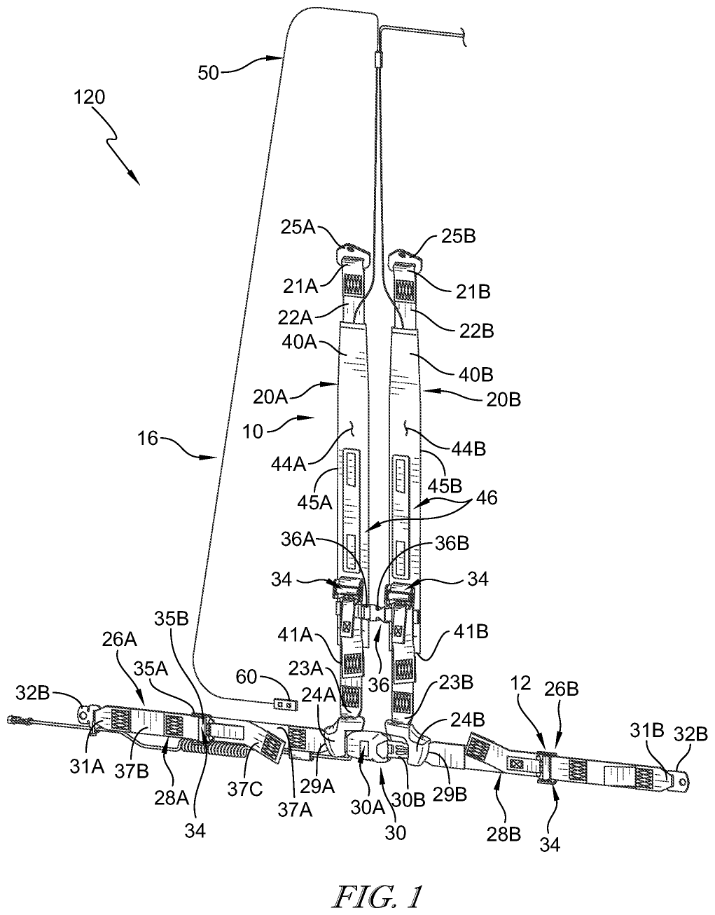

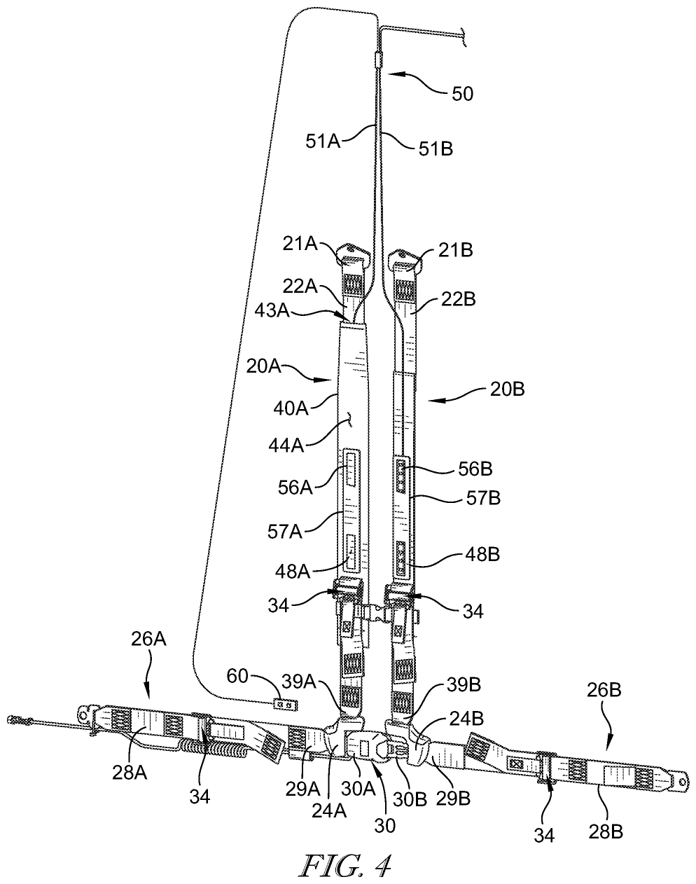

Referring now to FIGS. 1-7, an embodiment is shown of a multi-point motor vehicle seat restraint system 120 that forms an illuminated harness assembly 16. In an illustrated embodiment, the illuminated harness assembly 16 includes a restraint harness assembly 10 and an illumination assembly 46 as described herein.

In the illustrated embodiment, the restraint system 120 includes a multi-point restraint harness assembly 10 carried by a motor vehicle seat assembly (not shown). The seat assembly illustratively includes a seat bottom that corresponds to an occupant's bottom and legs, and a seat back that corresponds to an occupant's torso, chest and head, and the seat assembly is illustratively mounted to a floor or floor frame of a motor vehicle. The vehicle seat illustratively includes a seat bottom coupled to a seat back in a conventional manner. The motor vehicle in which the restraint system 120 is mounted may illustratively be any motor vehicle configured to transport at least one vehicle operator and/or occupant, and examples include, but are not limited to, an off-road recreational vehicle such as an all-terrain vehicle (ATV/UTV), dune buggy or other off-road vehicle, an automobile, a light, medium or heavy-duty truck, an electric vehicle, a utility vehicle, a commercial vehicle, an industrial vehicle, a racing vehicle, and the like.

The restraint harness assembly 10 that is coupled to the seat is a 4-point restraint harness assembly, and various web tightening apparatus 12 illustratively provide for selective adjustment, i.e., tightening and/or loosening, of the points of securement. It will be understood, however, that the restraint harness assembly 10 may include more or fewer points of securement and/or that the tightening apparatus 12 may be modified to provide for selective adjustment of more or fewer points of securement. Those skilled in the art will recognize that any such modifications will involve mere mechanical steps in view of the concepts illustrated and described herein.

In an illustrated embodiment, the 4-point restraint harness assembly 10 includes two shoulder portions 20A and 20B each configured to extend over a different shoulder or torso area of an occupant of the seat. The shoulder portions 20A and 20B include shoulder webs 22A and 22B configured to extend downwardly along either side of the torso of the occupant. In various embodiments, conventional web coupling members 24A, 24B are coupled to first ends 23A and 23B of the shoulder webs 22A and 22B respectively. The shoulder webs 22A, 22B may be separate from each other with each web coupled to different web retainer plates 25A and 25B at second ends 21A and 21B of the respective shoulder webs 22A and 22B to attach the shoulder portions 20A and 20B to the seat back, frame and/or floor or other support structure/surface within the motor vehicle. In still other alternative embodiments, the shoulder webs 22A, 22B may be attached directly to the seat bottom, the seat back and/or the floor or other support structure/surface within the motor vehicle (not shown).

Illustratively, the 4-point restraint harness assembly 10 further includes two lap portions 26A and 26B each configured to extend over a portion of a lap or waist of an occupant of the vehicle seat. The lap portions 26A and 26B include lap webs 28A and 28B having first respective ends 29A and 29B coupled to the web coupling members 24A, 24B respectively. The web coupling member 24A is illustratively coupled, e.g., via a web or other conventional manner, to a conventional buckle member 30A, and the web coupling member 24B is illustratively coupled to a conventional tongue member 30B, wherein the buckle member 30A and the tongue member 30B are configured to releasably engage one another in a conventional manner to releasably secure together the ends 23A, 23B of the shoulder webs 22A, 22B and the ends 29A, 29B of the lap webs 28A, 28B, so as to secure the shoulder webs 22A and 22B and the lap webs 28A and 28B to and about the occupant when seated on the vehicle seat. Together, the buckle member 30A and the tongue member 30B form a releasable web engagement assembly 30.

The lap webs 28A, 28B may be separate from each other with each coupled to a different web retainer plate 32A, 32B at second ends 31A and 31B of the respective lap webs 28A and 28B to attach the lap portions 26A and 26B to the seat bottom, seat back, and/or to the floor or other support structure or surface within the motor vehicle. In still other alternative embodiments, the lap webs 28A, 28B may be attached directly to the seat bottom, the seat back and/or the floor or other support structure or surface within the motor vehicle (not shown).

In other illustrative embodiments, additional releasable engagement members 36A and 36B may be connected to the shoulder webs 22A and 22B respectively between the first ends 23A and 23B and second ends 25A and 25B thereof to secure the first and second shoulder webs 22A and 22B together independently of the releasable web engagement assembly 30. In one embodiment, the engagement member 36A may be a tongue member and the engagement member 36B may be a buckle member, although in alternate embodiments the engagement member 36A may be a buckle member and the engagement member 36B may be a tongue member. In any case, engagement members 36A and 36B together form another releasable web engagement assembly 30.

The tongue and buckle members of the present disclosure are illustratively configured, in a conventional manner, for releasable engagement. For example, such members are configures such that, when engaged, the lap webs 28A and 28B and the shoulder webs 22A and 22B are secured together to effectively form securement around an occupant to the seat bottom and seat base.

As illustrated in FIGS. 1, 2 and 4, the shoulder webs 22A and 22B and lap webs 28A and 28B may include one or more length adjustment features 34 configured to permit lengthening or shortening of the webs 22A, 22B, 28A and 28B to secure around various sizes and shapes of an occupant wearing the restraint harness assembly 10. Various forms of the length adjustment features 34 are envisioned herein. An exemplary length adjustment feature 34 will be described herein regarding lap web 28A, with the understanding that such length adjustment features of the other webs will be substantially the same. The length adjustment feature 34 may illustratively be formed by a belt-receiving buckle member 35A and a belt retainer 35B engaged with the buckle member to lock or block movement of a belt received within the belt-receiving buckle member 35A, as illustrated by example in FIG. 1. A first belt 37A of the lap web 28A extends from the first end 29A. The buckle member 35A is attached to a second belt 37B of the lap web 28A extending from the second end 31A of the lap web 28A, and an end portion 37C of the first belt 37A is received within the buckle member 35A and retained in place by the belt retainer 35B when the lap web 28A is adjusted to a desired length. In various embodiments, the belt retainer 35B may include a ratchet mechanism or other similar mechanism (not shown) that can be manually operated to disengage a lock of the belt retainer 35B to permit selective adjustment of the first belt 37A to move freely through the buckle member 35A when adjustment is desired (i.e. tightening or loosening).

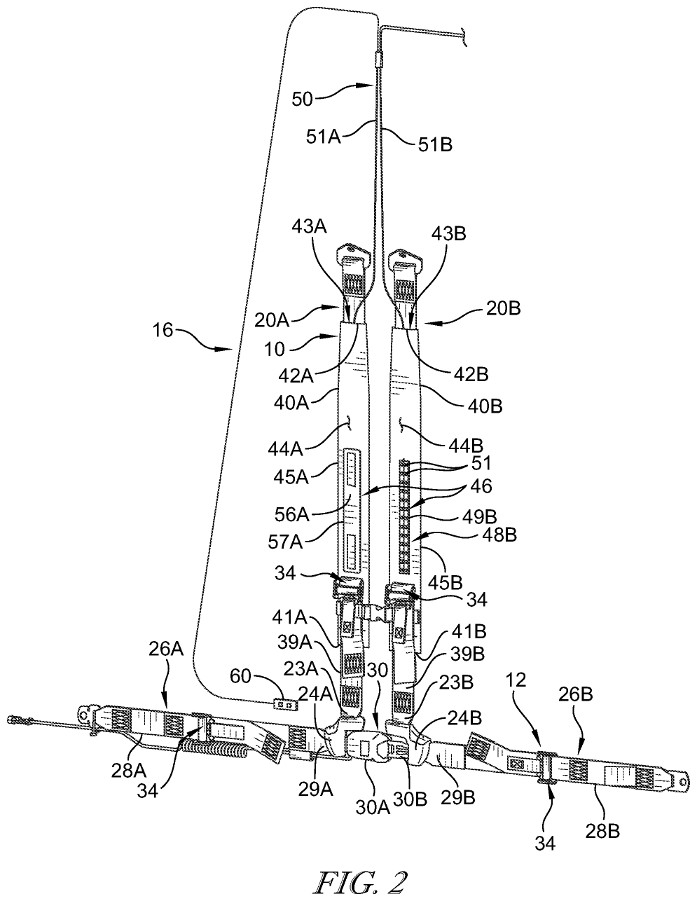

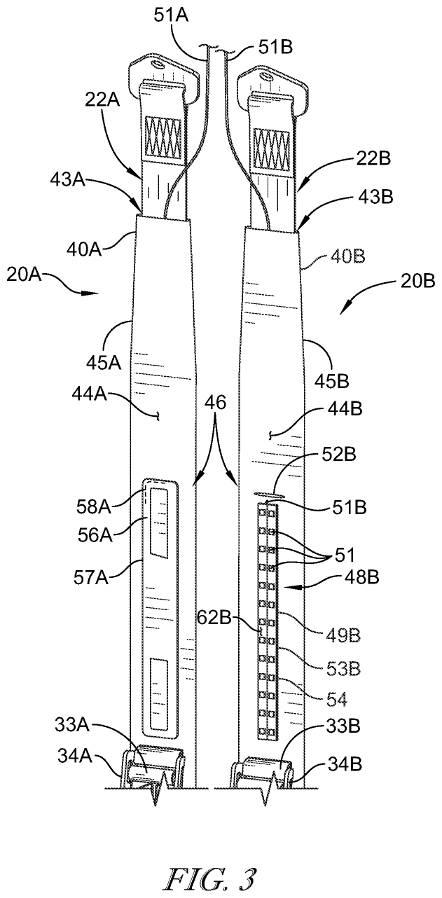

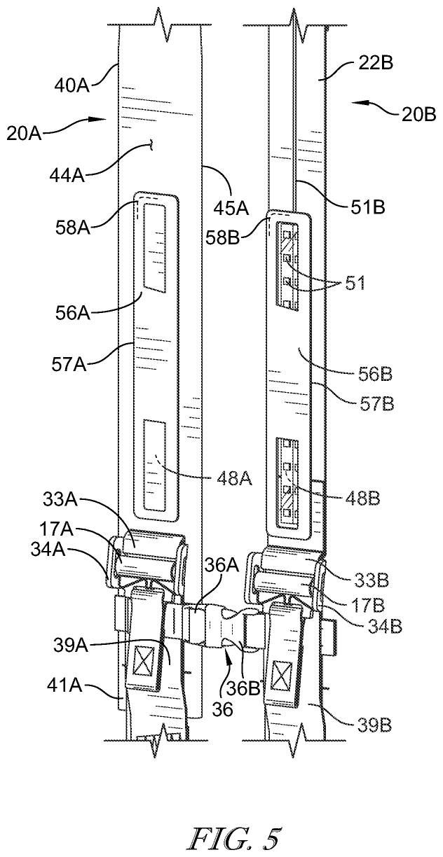

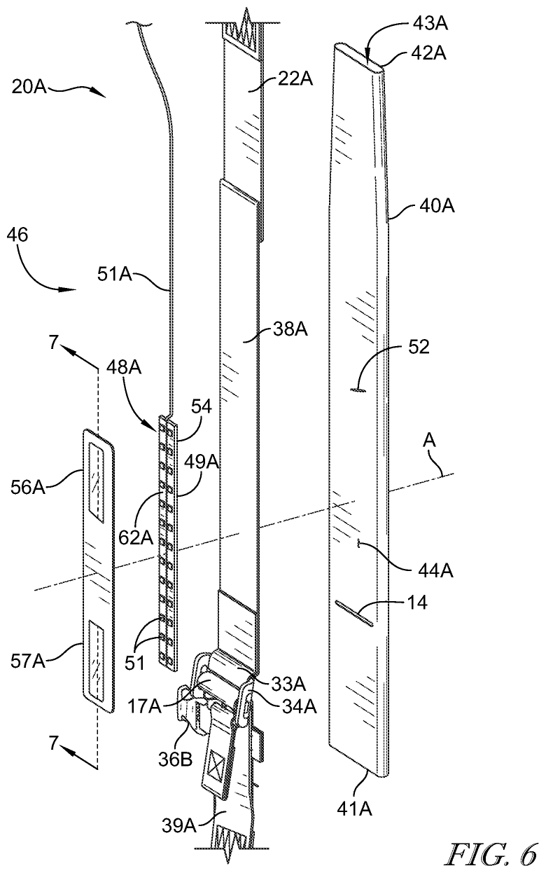

As illustrated in FIGS. 2 and 3, the shoulder portions 20A and 20B are configured with harness pads 40A and 40B that extend transversely, e.g., circumferentially, at least partially around the shoulder webs 22A and 22B. The harness pads 40A and 40B may be formed of various materials, and illustratively may be formed of a fabric material. The harness pads 40A and 40B include first ends 41A and 41B and second ends 42A and 42B, and a belt passage 43A and 43B may be configured to extend through the harness pads 40A, 40B between the first ends 41A and 41B and the second ends 42A and 42B. The belt passage 43A and 43B is configured to receive a portion of the shoulder webs 22A and 22B with the shoulder webs 22A and 22B extending through the second ends 42A and 42B. In various embodiments, the shoulder webs 22A and 22B may extend through the passages 43A and 43B and out from the first ends 41A and 41B. Alternatively, the shoulder webs 22A and 22B may be formed of a first belt 38A and 38B (only 38A shown by example in FIG. 5) and a second belt 39A and 39B. The first belt 38A and 38B of the shoulder webs 22A and 22B may extend within the passages 43A and 43B and terminate therewithin at first ends 33A and 33B of the first belt 38A and 38B. The second belt 39A and 39B of the shoulder webs 22A and 22B may extend from the first ends 23A and 23B of the shoulder webs 22A and 22B to second ends 17A and 17B of the second belt 39A and 39B. Second ends 17A and 17B of second belt 39A and 39B may be configured to be received within an adjustment feature 34 that is secured adjacent the first end 41A and 41B of the harness pads 40A and 40B. In various embodiments, first ends 33A and 33B of the first belt 38A and 38B may be configured to be coupled to a portion of the adjustment feature 34A and 34B, and second ends 17A (and 17B) may be coupled to a second portion of the adjustment feature 34A (and 34B), as illustrated by example in FIGS. 5 and 6.

The adjustment features 34A and 34B of the shoulder portions 20A and 20B (see, e.g., FIG. 5) may extend at least partially within the belt passage 43A and 43B of the harness pads 40A and 40B. The adjustment features 34A and 34B may alternatively be positioned along the front surface 44A and 44B of the harness pads 40A and 40B and the first ends 33A and 33B of the first belt 38A and 38B may extend through a slit or opening 14 in the front surface 44A and 44B to be coupled to the adjustment features 34A and 34B, as illustrated for example in FIGS. 3 and 5-7.

The harness pads 40A and 40B are configured to include front surfaces 44A and 44B and back surfaces 45A and 45B. The back surfaces 45A and 45B are configured to face or abut against a chest or torso of an occupant of the vehicle seat when the occupant is wearing the restraint harness assembly 10. The front surfaces 44A and 44B are configured to face away from an occupant, and in particular, configured to face toward the front portion of the vehicle (such as the dashboard) and be visible from an exterior of the vehicle (e.g. through a window or other opening in the vehicle frame).

In various embodiments, an illumination or light assembly 46 is coupled to the harness pads 40A and 40B to provide for illumination along the front surfaces 44A and 44B of the harness pads 40A and 40B. In an illustrative embodiment, the illumination assembly 46 includes a first illumination unit 48A coupled to the harness pad 40A, a second illumination unit 48B coupled to the harness pad 40B, and a wiring system 50 that electronically couples to the first and second illumination units 48A and 48B. The illumination units 48A and 48B are substantially similar and accordingly the description of illumination unit 48B herein will apply substantially similar to the illumination unit 48A.

As illustrated in FIGS. 2 and 3, the illumination unit 48B includes a light module or bar 49B comprised of one or more lights 51 that are electronically controlled and can be activated by the wiring system 50. In various embodiments, the light module 49B may be an LED strip (e.g. 5050 RGC and White with silicon rated at IP6, or an SAEJ1455), although other modes of providing lights are envisioned herein. In some embodiments, the one or more lights 51 may each be configured to emit visible radiation in a single, common color. In other embodiments, one or more of the lights 51 may be configured to emit visible radiation in a first color, and one or more of the remaining lights 51 may be configured to emit visible radiation in a second color that is different from the first color. In still other embodiments, single color lights 51 may be used to emit visible radiation in three or more different colors. In still further embodiments, one or more of the lights 51 may be configured to emit visible radiation in any of a plurality of different colors, and such one or more lights 51 are illustratively configured to be controllable, e.g., via one or more control signals, to emit visible radiation in any such color.

The light module 49B may be configured as a flexible or bendable unit that can adjust shape with flexing movement of the shoulder web 22B and harness pad 40B. In various embodiments, the light module 49B may include a front surface 62B upon which the lights 51 are secured to project light from the front surface 62B. The light module 49B further includes a back surface 53B that is positioned adjacent to, or secured to a portion of, the harness pad 40 and/or the shoulder web 22B. In various embodiments, the back surface 53B may include an adhesive material 54 that can be used to secure the light module 49B in a secure position on the harness pad 40B. Other forms of securement of the light module 49B and/or of the illumination unit 48B generally are envisioned herein.

The illumination assembly 46 further includes one or more controllers 60 that are electronically connected to the illumination units 48A and 48B via the wiring assembly 50. The controller 60 may be in a variety of forms, and illustratively includes the ability to turn on/off the illumination units 48A and 48B as well as to alter the type (e.g. solid, flashing, strobe, illumination strength, etc.) and/or color of light emitted from the illumination units 48A, 48B. The wiring assembly 50 is configured to extend from the controller 60 and includes first and second wires 51A and 51B that extend through the second ends 42A and 42B of the harness pads 40A and 40B. The first and second wires 51A and 51B are configured to extend within the belt passages 43A and 43B, respectively, and may be extended through a slit or opening 52A and 52B in the front surface 44A and 44B of the harness pads 40A and 40B to be electrically connected with the illumination units 48A and 48B.

In illustrative embodiments, the illumination assembly 46 further includes light-transmissive, e.g., transparent or translucent, patches or covers 56A and 56B positioned over the illumination units 48A and 48B and secured to the front surfaces 44A and 44B of the harness pads 40A and 40B. The patches or covers 56A, 56B are configured to be light-transmissive so as to permit visible radiation emitted by the illumination units 48A, 48B to pass through or back-light the patches 56A and 56B and be viewed by someone within the line of sight of the front surfaces 44A and 44B of the harness pads 40A and 40B. In various embodiments, the patches or covers 56A and 56B may be configured with a logo or other design that is illuminated or backlit by the illumination units 48A and 48B. As illustrated, the light-transmissive patches 56A and 56B are attached to the front surface 44A and 44B of the harness pads 40A and 40B via stitching 58A and 58B adjacent and around a perimeter 57A and 57B of the patches 56A and 56B. The stitching 58A and 58B may be arranged to secure the light modules 49A and 49B between the patches 56A and 56B and the front surfaces 44A and 44B in a generally fixed position, The patches 56A and 56B may be positioned on the front surface 44A and 44B to cover or encompass the slits 52A and 52B within the circumference of the stitching 58A and 58B so that the slits 52A and 52B are not visible from the front surfaces 44A and 44B when the patches 56A and 56B are attached thereto.

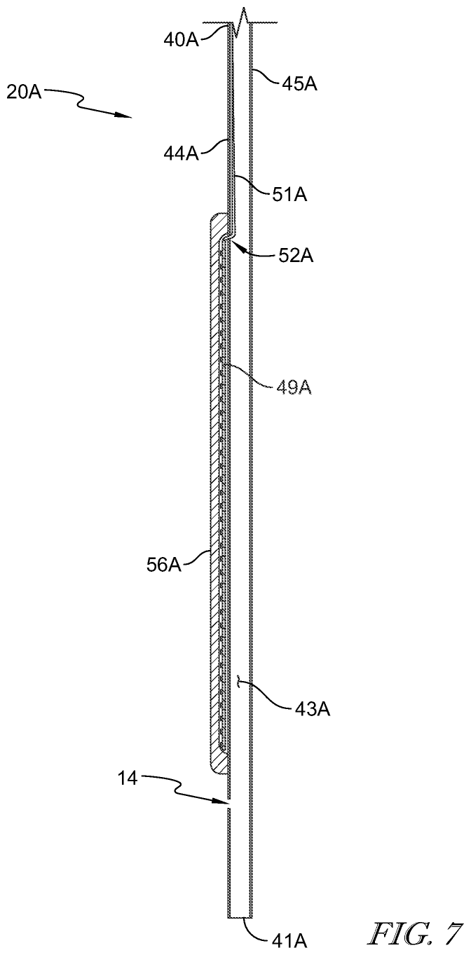

FIG. 6 illustrates an exploded view of one of the shoulder portions 20A. As illustrated in FIG. 6, the harness pad 40A, shoulder web 22A, light module 49A and light-transmissive shield or cover 56A are substantially aligned vertically with each other such that the harness pad 40A, light module 49A, and cover 56A are aligned along an axis A that is generally along a central portion of the shoulder web 22A, although other embodiments and alignments are envisioned herein. The positioning of the light module 49A and cover 56A along the shoulder web 22A may be configured in a position that will permit light emitted by the module 49A to be visible from an exterior portion of the vehicle when the shoulder portions 22A are positioned over an occupant, such that the illuminated harness assembly 16 can be easily seen by others for safety, security, and attraction of attention. FIG. 7 is a cross-sectional view of one of the shoulder portions 20A, as viewed along section lines 7-7 of FIG. 6, illustrating the positioning of the light module 49A and weaving of the wiring 51A connected thereto when the illuminated harness assembly 16 is assembled.

In some embodiments, the harness pad 40A and the harness pad 40B are each illustratively formed of a unitary sheet of fabric or other suitable flexible or semi-flexible material. In alternate embodiments, the harness pad 40A and/or the harness pad 40B may be formed of multiple sheets of fabric or other suitable flexible or semi-flexible material. In one illustrative example, which should not be considered limiting in any way, a harness pad 40A, 40B may be formed of a unitary sheet of fabric or other flexible or semi-flexible material(s). The sheet illustratively has a top edge, a first side edge, a second side edge, and a bottom edge, and the slit 52A, 52B is formed within an interior region of the sheet that eventually becomes the front surface 44A, 44B when the harness pad 40A, 40B is fully formed. The slit 52A, 52B is illustratively sized to receive the light module 49A, 49B connected to the respective wire 51A, 51B. The light module 49A, 49B is then coupled to the sheet via, for example, adhesive material 54, and the light-transmissive patch 56A, 56B is secured to the sheet via the stitching 58A, 58B adjacent the perimeter 57A, 57B of the patch 56A, 56B. The first and second side edges of the sheet 70 are then folded together, and are stitched together along a length of the sheet to form a looped material that contains the patch 56A, 56B and light module 49A, 49B within an interior passageway 43A, 43B of the looped material opposing ends of the looped material. The wiring 51A, 51B extends outside of the slit 52A, 52B to an exterior of the looped material. The looped material is then turned inside-out by pushing the second end through the passageway and out through the first end (or vice versa) to form the harness pad 40A, 40B with the belt passageway 43A, 43B to receive the shoulder web 22A, 22B. The wiring 52A, 52B then extends within the belt passageway 43A, 43B that is formed in and through the harness pad 40A, 40B, and the light module 49A, 49B and patch 56A, 56B are positioned along the front surface 44A, 44B of the harness pad 40A, 40B. Using this example, a harness assembly 10 may be produced by forming a sheet of flexible material with a top edge, a bottom edge, and first and second longitudinal side edges extending between the top and bottom edges, the first and second longitudinal side edges having a longer length than the top edge or bottom edge, placing a slit within the sheet of flexible material between the two side edges, inserting an illumination unit of an illumination assembly through the slit to be positioned along a first surface of the sheet, the illumination unit including a wiring assembly extending through the slit, securing the illumination unit to the first surface of the sheet, securing a light-transmissive cover to the first surface of the sheet, the light-transmissive cover being positioned over the illumination unit and the slit, folding the first and second longitudinal side edges together and securing the side edges together from the top edge to the bottom edge to form a tubed structure having a passageway containing the illumination unit and light-transmissive cover, pushing the top edge through the passageway of the tubed structure and out through the bottom edge to turn the tubed structure inside-out and position the illumination unit and light-transmissive cover along an exterior of the tubed structure to form a harness pad including a webbing passageway, and placing a webbing material through the webbing passageway of the harness pad, the webbing passageway further including a portion of the wiring assembly extending from the slit.

The illumination assembly 46 may be configured to emit multiple or various colors of light, and can further be configured to emit certain colors of light depending on the choice of an occupant or the status of a particular situation. For instance, the color emitted by the light module 49A and 49B may be controlled by the controller 60 to permit an occupant to add features (e.g. interior lighting, caution lighting) to the harness that is in accordance with user desires. A user could press a button on the controller 60 multiple times to cycle through various color options until a desired option is provided. The illumination assembly 46 may be further configured to emit a specific color (e.g. green or red) when the vehicle is first turned on. Other factors may cause certain colors to be presented, depending on how electronic control of the controller 60 is programmed for the illumination assembly 46.

The colors of the light may further be dependent on the status of the connection of the harness assembly 10 to a buckle or harness lock (not shown) that is secured to the frame of the vehicle. For instance, if the vehicle is turned on, but the harness has not be secured to an appropriate buckle receiver (not shown) in the vehicle, the light emitted from the illumination assembly 46 may be, for example, red to show caution or concern that the harness assembly is not properly securing an occupant. When the harness assembly 10 is properly buckled, the light emitted may be, for example, green to indicate to the occupant that they are safely secured and can begin operating the vehicle. This buckle connection indicator provides an additional level of security when the user starts the vehicle. In addition, the illumination assembly 46 could be programmed not to permit changing of the color of light emitted until the harness assembly 10 is properly buckled, providing for a reward system for proper use of the harness assembly 10. Promoting the safety that a user buckles oneself into the vehicle based on the illumination unit, and allowing the user the then select a desired light to emit once properly buckled, provides positive feedback to the user and reinforces proper safety measures.

The present disclosure is not considered to be limited to a 4-point harness assembly. For instance, a harness assembly and illumination assembly of the present disclosure may be configured to include a 3-point harness assembly such that only one harness pad and light assembly are provided for each harness assembly. Other embodiments are also envisioned herein.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected.

1. A harness assembly for a vehicle, comprising:
a shoulder harness portion configured to extend around a torso area of an occupant of the vehicle, the shoulder harness portion comprising:
a webbing configured to be secured to a frame of the vehicle;
a harness pad extending at least partially about the webbing to define a web passage through which the webbing extends, the harness pad including a front surface visible from outside of the vehicle, the webbing extending into the web passage via an opening at a first end of the harness pad; and
an illumination assembly that includes a light module configured to emit light and a wiring assembly coupled to the light module, the light module coupled to the front surface of the harness pad;
wherein the wiring assembly extends through a slit in the front surface of the harness pad to extend into the web passage, and the wiring assembly further extends through the web passage and through the opening at the first end of the harness pad.

2. The harness assembly of claim 1, wherein the assembly further includes a light-transmissive cover secured to the harness pad over the light module and slit formed in the front surface of the harness pad.

3. The harness assembly of claim 1, wherein the assembly further includes a controller electrically coupled to the wiring assembly to control activation of the light module.

4. The harness assembly of claim 1, wherein the assembly further includes a waist harness portion configured to extend around a waist area of the occupant, the waist portion configured to be secured to the shoulder harness portion via a releasable engagement assembly.

5. The harness assembly of claim 4, wherein both the shoulder harness portion and the waist harness portion are each adjustable in length.

6. The harness assembly of claim 2, wherein the light-transmissive cover includes an icon, and light emitted from the light module extends through only a first portion of the icon, and a second portion of the icon does not permit light from the light module to extend therethrough.

7. The harness assembly of claim 1, wherein the light module includes at least one LED.

8. The harness assembly of claim 1, wherein the light module is coupled to the front surface of the harness pad via adhesive.

9. The harness assembly of claim 1, wherein the harness pad is assembled from a sheet of fabric including the slit, and the wiring of the illumination assembly is threaded through the slit before the harness pad is formed to include the web passage.

10. The harness assembly of claim 9, wherein the sheet of fabric includes two side edges that are secured together to form a tubed structure surrounding the light module.

11. The harness assembly of claim 1, wherein the harness assembly includes two shoulder harness portions configured to extend adjacent to two respective shoulders of an occupant.

12. The harness assembly of claim 1, wherein the light module is configured to emit multiple colors of light.

13. The harness assembly of claim 12, wherein the color of light emitted from the light module depends on a lock status of the harness assembly to a fixed structure within the vehicle.

14. The harness assembly of claim 12, wherein the light module is configured not to emit light unless the harness assembly is lockingly secured to a harness buckle coupled to the vehicle frame.

15. A method of assembling a harness assembly for a vehicle, the method comprising:
forming a sheet of flexible material with a top edge, a bottom edge, and first and second longitudinal side edges extending between the top and bottom edges, the first and second longitudinal side edges having a longer length than the top edge or bottom edge;
forming a slit within the sheet of flexible material between the two side edges;
positioning an illumination unit of an illumination assembly along a first surface of the sheet, the illumination unit including a wiring assembly extending through the slit;
securing the illumination unit to the first surface of the sheet;
securing a light-transmissive cover to the first surface of the sheet, the light-transmissive cover being positioned over the illumination unit and the slit;
folding the first and second longitudinal side edges together and securing the side edges together from the top edge to the bottom edge to form a tubed structure having a passageway containing the illumination unit and light-transmissive cover;
pushing the top or bottom edge through the passageway of the tubed structure and out through the bottom or top edge to turn the tubed structure inside-out and position the illumination unit and light-transmissive cover along an exterior of the tubed structure to form a harness pad including a webbing passageway extending therethrough; and
placing a webbing material through the webbing passageway of the harness pad, the webbing passageway further including a portion of the wiring assembly extending from the slit.

16. A harness assembly for a vehicle, comprising:
a shoulder web configured to extend about a torso area of an occupant of the vehicle;
a harness pad having an interior surface extending at least partially about the shoulder web to define a web passage through which the shoulder web extends; and
an illumination assembly coupled to exterior surface of the harness pad opposite the interior surface, the illumination assembly including a light module configured to emit light away from the exterior surface of the harness pad and a wiring assembly coupled to the light module;
wherein the wiring assembly extends through a slit defined through the harness pad to extend into the web passage, and the wiring assembly further extends, along with the web, through the web passage and out of one end of the harness pad.

17. The harness assembly of claim 16, wherein the assembly further includes a light-transmissive cover secured to the exterior surface of the harness pad over the light module and the slit defined through the harness pad.

18. The harness assembly of claim 17, wherein the light-transmissive cover includes an icon, and light emitted from the light module extends through only a first portion of the icon, and a second portion of the icon does not permit light from the light module to extend therethrough.

19. The harness assembly of claim 16, wherein the light module includes at least one LED.

20. The harness assembly of claim 16, wherein the assembly further includes a controller electrically coupled to the wiring assembly to control activation of the light module.
